(19) United States
(12) Patent Application Publication
(10) Pub. No.: US 2014/0099415 A1
(43) Pub. Date: Apr. 10, 2014

(54) APPARATUS AND METHODS FOR COOKING FUNNEL CAKE

(71) Applicant: GOLD MEDAL PRODUCTS COMPANY, Cincinnati, OH (US)

(72) Inventor: TIMOTHY A. RHOME, Milford, OH (US)

(73) Assignee: Gold Medal Products Company, Cincinnati, OH (US)

(21) Appl. No.: 13/645,550

(22) Filed: Oct. 5, 2012

(51) Int. Cl. A23P 1/10; A21D 13/08; A47J 37/12

(52) U.S. Cl. 426/421; 249/203; 99/403

(57) ABSTRACT

A funnel cake mold preferably has multiple mold cavities, each with opposed slotted ends for releasably receiving a stick extending from within the cavity and outwardly from both ends. The mold is placed in a hot oil fryer and funnel cake batter is poured into each cavity where it is partially cooked around the stick. The sticks and partially cooked cake is removed from the mold and remain in the oil for final cooking. Preliminarily, sticks are oriented on a floating frame, each stick in register with a mold cavity pressed down over the sticks to releasably retain them in a respective cavity. The cake on a stick can then be handled and eaten from the stick. Methods are disclosed.

### FIELD OF THE INVENTION

This invention relates to foods such as funnel cake, and to apparatus and methods for making funnel cakes for human consumption.

### BACKGROUND OF THE INVENTION

Funnel cakes constitute a popular, cake-like food for consumption made from a batter which has a low or non-existent yeast component, i.e. is unleavened. Typically, funnel cakes are cooked and served with sugar, icing or other toppings as confections in concession operations such as fairs, bazaars, carnivals, circuses, sporting events and the like, although funnel cakes can be prepared in homes, restaurants or other places for consumption. Typically, batter is applied to a hot oil in a receptacle where the batter is cooked to produce an edible, cake-like food.

It is now desirable to prepare funnel cakes in an elongated format, making them easier to handle and eat, particularly as served in a concession. Moreover, it is desirable to prepare an elongated funnel cake on a stick for easy handling and eating, made much like the well known “corndog”, for example.

To provide such a product, one recent process involves a pre-baked, elongated funnel cake on a stick, typically frozen, and which is removed from packaging, then finally cooked in hot oil.

It is now desirable to provide apparatus and methods for preparing and cooking elongated funnel cakes on a stick from the uncooked, cake batter state.

### SUMMARY OF THE INVENTION

To this end, a platform and a funnel cake mold is provided for placement in a fryer, for example, containing hot oil. Sticks are removeably secured in each cake mold cavity. Funnel cake batter is poured into each mold cavity around the sticks immersed in cooking oil. The batter is initially cooked or fried and “set” about the stick in each mold. After a bit of frying, the sticks are removed from the mold, with the sticks with the partially-cooked funnel cake thereon remaining in the fryer where they float freely. The hot oil finally cooks the funnel cakes in an elongated shape on the sticks. These are removed in the form of a cooked, elongated, funnel cake finger on a stick for toppings, serving and consumption.

A mold according to the invention comprises a multiple cavity mold, each cavity in the general form of a funnel cake shape as finally desired. Each mold cavity has, at each end, a stick receiving slot with a spring detent or other suitable mechanism for removeably holding a near end of a stick, and in a position where the stick extends through the cavity and out the other end, Thus, the stick has two ends, each freely extending from the cavity and outwardly from the cavity. The stick in each cavity is releasably received in a stick-support structure in or adjacent the cavity ends.

In use, the mold is first pressed down onto an array of sticks in a loading frame. The mold, with the sticks releasably secured in each cavity, is placed in a hot oil fryer and onto a platform therein. Batter is poured into each cavity and is partially cooked where, then, the sticks with the partially cooked batter are pushed from the mold and left in the hot oil while the mold is removed. The partially cooked batter forming a unitary, stick-mounted funnel cake finger on a stick and from each mold cavity is finally cooked in the hot oil.

To removeably support the noted stick in the cavity, each cavity mold end preferably comprises a slot and a yieldable spring or detent tab disposed proximate the slot. Insertion of the stick fully into the slot as the mold is pressed down onto the array of aligned sticks in the loading frame moves the detent tab first away, then back toward the stick with the detent and slot at each end operable to releasably capture the stick and hold it in place within a space for the initial batter poured into the cavity, while initial cooking is performed. The entire multiple cavity mold is then lifted from the fryer loading platform and placed in the fryer with batter being poured into each cavity around the stick therein. The sticks with partially-cooked batter thereon are then pushed out of the respective slots and mold cavity, against the spring bias, and remain in the oil for final cooking. The mold is removed and can be pushed onto the loading frame for new sticks and a fresh batch of cakes.

In this manner, batter can be made at the preparation site so it is fresh. Pre-baking is not required. Moreover, there are no frozen, partially cooked components requiring special storage or handling, and the batter can be used both for the on-stick funnel cakes and funnel cakes in other forms, simplifying the concessionaire's processes. The molds can be of single or multiple cavity structure and reused as soon as the sticks are removed. Moreover, the molds can be used in any fryer of a size sufficient to accommodate the mold size. Non-stick coatings can be applied to the molds for product quality and easy cleanup.

These and other advantages and modifications will become readily apparent from the following detailed written description and from the drawings in which:

### BRIEF DESCRIPTION OF THE DRAWINGS

FIG. 1 is an isometric view of a multi-cavity funnel cake mold according to the invention and showing three funnel cake sticks in place on loading frame, indexed for mold pick up;

FIG. 2 is an isometric view of a mold and mold platform disposed in a fryer with batter being poured into the mold cavities; and

FIG. 3 is an isometric illustration of a cooked funnel cake on a stick ready for consumption.

### DETAILED DESCRIPTION OF THE INVENTION

Turning now to the drawings, a finished, fully-cooked funnel cake 10 on a stick 11 is shown in FIG. 3. The elongated cake or finger 10 can receive toppings of sugar, icing, glaze, fruit or the like and is served, for example, as a confection, preferably on the stick.

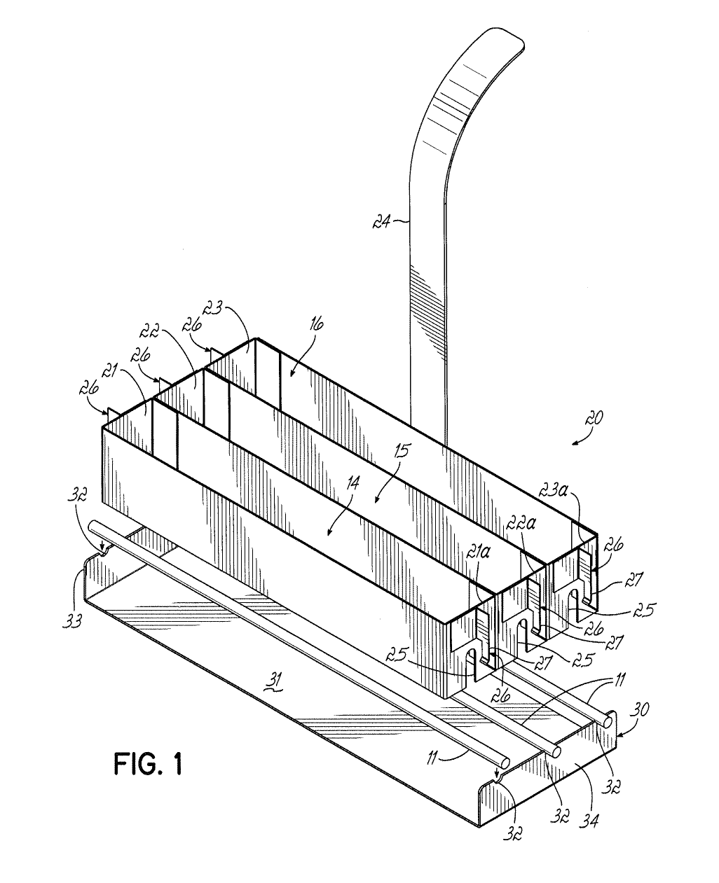

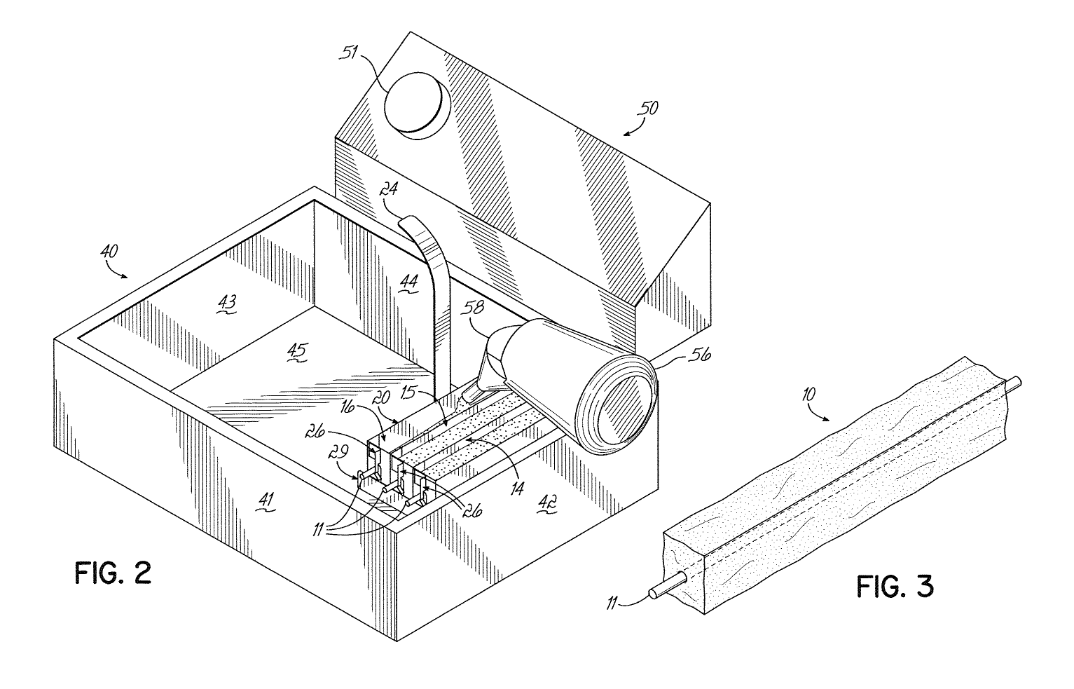

The mold 20 of the invention is shown in FIGS. 1 and 2. In FIG. 1, the mold 20 is illustrated with three cavities 14, 15, 16, but could have any suitable number of cavities. Mold 20 can be made of any suitable material, including but not limited to stainless steel, and can be coated with a suitable non-stick coating. The mold may be formed with cavities 14-16 integrally joined. A handle 24 extends upwardly from the mold, for placing and removing mold 20 in the fryer. Cavities 14-16 may be in any desired shape and are preferably elongated in square or rounded cross-section.

Preferably, mold 20 is pressed onto a stick loading frame 30, then placed upon a platform 29 having a flat surface for supporting mold 20 at a desired height within a fryer 40.

In FIG. 1, each mold cavity 14-16 has a closed end 21, 22, 23 with opposite ends 21a, 22a, 23a, respectively opposed, each with a similar slot 25 therein. Slots 25 are not shown in the ends 21-23 of FIG. 1 for clarity. A spring tab 26 is mounted on each end 21-23 and 21a, 22a and 23a in a position to yieldably and operably interfere with slots 25 at each end of each mold cavity 21-23, 21a-23a. Tabs 26 include a yieldable finger 27 with a curled end, as shown, for yieldably engaging and holding sticks 11 in slots 25 and in position in the mold cavities at each end thereof, with sticks 11 extending longitudinally through the mold cavity.

Loading frame 30 has two end flanges, 33, 34 extending upwardly from bottom 31. Flanges 33, 34 have upper edges in which are found cradles or notches 32 for holding aligned sticks 11 therein at each end of frame 30 at position laterally outside the ends 21-23 and 21a-23a of mold cavities 14-16. The notches 32 are aligned with the slots 25 respectively in the ends of the mold cavities 14-16, so that a stick is positioned for receipt in a respective slot 25 when the mold 20 is pressed down onto the frame 30.

The fingers yield upon manual pressure by the mold pressing downwardly to receive the sticks and by downward pressure on the stick ends to release sticks 11 with partially-cooked funnel cakes thereon.

Mold 20 is shown in FIG. 2 disposed or lowered into a fryer 40 having walls 41-44 and bottom 45.

Mold 20 is disposed on a platform 29 in fryer 40 for batter loading and initial partial cooking. Fryer 40 is operably associated with any suitable form of controlled heater 50, preferably including a means such as a knob 51 and suitable control (not shown) for setting and maintaining a desired oil temperature in fryer 40. For clarity, no oil is shown in FIG. 2. Platform 29 can be fixed within the fryer but is preferably removable for cleaning, for example.

For description, FIG. 2 also illustrates a pitcher 56 for containing and pouring funnel cake batter, and a funnel 58 for directing batter into mold cavities 21, 22 and 23.

It will be appreciated that when in fryer 40 for cooking, the mold 20 is disposed on platform 29 therein so the mold is covered by cooking oil therein.

In use, a mold 20 is pushed down onto frame 30 such that sticks 11 in the recesses or notches 32 are releasably located in mold slots 25. A slot 25 at each end 21-23 and 21a-23a of each cavity receives a stick 11, corresponding notches 32 at each end of the frame 30 corresponding to one mold cavity 14-16 to hold a stick for placement therein. Downward motion of the mold 20 causes the tabs 26 to engage and yieldably receive a stick 11 in the associated slot 25, the downward motion onto the frame 30 positioning the mold 20 such that respective sticks 11 are releasably captured in slots 25 at the ends of the mold cavities 14-16.

The mold with sticks 11 in place is then lifted away from the now empty frame 30 and placed on the platform 29 in the fryer with the cavities 14-16 under the surface of the cooking oil. Batter is poured into the cavities 14-16 and partially cooked in the hot oil in fryer 40.

Thereafter, the sticks 11 with partially cooked batter are removed from the slots 25, such as with tongs or other implements. The sticks 11 with partially cooked batter remain in the hot oil of the fryer to finish cooking.

New sticks 11 can then be placed in the notches 32 of frame 30 and the process repeated. To that end, the frame 30 is reloaded with new sticks. Mold 20 can then be lowered onto platform 29 after the prior finally-cooked funnel cakes are removed or reoriented in the fryer.

Accordingly, no frozen components are used as would present storage or handling problems. Funnel cakes are prepared from fresh batter and on a stick for easy topping application and consumption. Batter can be used both for the disclosed funnel cakes on a stick and for funnel cakes in other forms.

Moreover, it will be appreciated that any suitable yieldable mechanism for yieldably received and releasably holding the sticks in the mold cavities can be used. For example, ball and detent, magnetic or other devices could be used.

These and other modifications and variations of the invention will be readily appreciated by the foregoing to those of ordinary skill in the art without departing from the scope of the invention and applicant intends to be bound only by the claims appended hereto.

What is claimed is:

1. A funnel cake mold having at least one mold cavity and comprising:
at least one cavity end;
a slot in said end; and
means for holding a stick within said slot extending from said slot.

2. A mold as in claim 1 wherein said means releasably holds said stick in said cavity with ends of said stick extending through a slot at each end of a cavity.

3. A mold as in claim 1 having multiple cavities.

4. A mold as in claim 1 having a handle extending therefrom.

5. A mold as in claim 1 and further including the combination with the mold of a fryer and a platform within the fryer for supporting said mold.

6. A mold as in claim 1 including an opposed end in each cavity and a slot in each cavity end.

7. A mold as in claim 6 wherein said means comprises a yieldable stick engaging finger operatively associated with each slot.

8. A mold as in claim 1 including a plurality of mold cavities,
each cavity having two opposed ends,
a stick receiving slot in each end, and
means proximate each slot and operatively associated with each slot for releasably receiving and holding a stick therein.

9. A mold as in claim 8 wherein said means comprises a yieldable finger disposed proximate each slot.

10. A mold apparatus as in claim 1 further including a stick positioning frame, said frame having upraised ends and stick positioning notches in edges of said upraised ends, said slots indexed with said notches for aligning a stick with said slots when a mold is moved toward said frame.

11. Apparatus as in claim 10 wherein said notches are positioned in sets of two notches, each aligned with a longitudinal mold cavity.

12. A funnel cake mold having at least one mold cavity, said cavity having two ends; and
a stick receiving slot at each end of said cavity for receiving a stick therein extending through said cavity and on which a funnel cake can be formed.

13. A mold as in claim 12 including a yieldable element in proximity to said slot selectively engageable with a stick.

14. A method of making a funnel cake on a stick for human consumption of the cake and comprising the steps of:
securing a stick in a mold with a portion of a stick disposed within the mold and another portion disposed outside the mold;
orienting said mold in cooking oil;
delivering funnel cake batter to said mold around said stick portion therein;
at least partially cooking said batter around the stick position in the mold.

15. A method as in claim 14 including the step of:
removing the partially cooked batter and stick from the mold; and
further cooking the batter on the stick in said cooking oil.

16. A method as in claim 14 including the preliminary step of releasably securing a stick in said mold by moving said mold onto said stick and releasably securing said stick in said mold.
